(19) United States
(12) Patent Application Publication
(10) Pub. No.: US 2026/0356360 A1
(43) Pub. Date: Nov. 12, 2026

(54) METHOD FOR OPERATING A DRIVER ASSISTANCE SYSTEM, CONCERNING AT LEAST LONGITUDINAL GUIDANCE OF A MOTOR VEHICLE, FOR A MOTOR VEHICLE

(71) Applicant: Valeo Schalter und Sensoren GmbH, Bietigheim-Bissingen (DE)

(72) Inventor: Chen Ding, Bietigheim-Bissingen (DE)

(73) Assignee: Valeo Schalter und Sensoren GmbH, Bietigheim-Bissingen (DE)

(21) Appl. No.: 19/139,125

(22) PCT Filed: Dec. 12, 2023
(86) PCT No.: PCT/EP2023/085243

§ 371 Date: Jun. 13, 2025

(30) Foreign Application Priority Data
Dec. 15, 2022 (DE) 10 2022 133 406.6

(51) Int. Cl. B60W 30/16; B60W 10/184; B60W 50/00; B60W 50/14

(52) U.S. Cl. CPC B60W 30/16; B60W 10/184; B60W 50/0097; B60W 50/14; B60W 2050/0088; B60W 2520/10; B60W 2554/4045; B60W 2554/802; B60W 2554/804; B60W 2710/18

(57) ABSTRACT

Described is a method for operating a driver assistance system concerning longitudinal guidance of a motor vehicle. The method includes providing sensor information describing another motor vehicle located ahead of the motor vehicle in a direction of travel of the motor vehicle and determining hazard warning light information describing whether or not the other motor vehicle has an activated hazard warning light by applying a hazard warning light recognition criterion to the provided sensor information. When the other motor vehicle has the activated hazard warning light, a time difference value describing a maximum time difference between a trigger time of a function of the driver assistance system and a collision point of a predicted collision between the motor vehicle and an obstacle in surroundings of the motor vehicle is increased by a predefined time interval. The driver assistance system is operated taking into consideration the increased time difference value.

The invention relates to a method for operating a driver assistance system for a motor vehicle. The invention also relates to a motor vehicle, a control device for a motor vehicle, and a computer program product for carrying out a method of this kind.

A motor vehicle can have a driver assistance system that relates to a longitudinal guidance of the motor vehicle. The driver assistance system can be designed, for example, to actuate a longitudinal guidance of the motor vehicle at least semiautomatically, in particular fully automatically. The driver assistance system can thus actuate, for example, a braking system of the motor vehicle. Such a driver assistance system is, for example, an autonomous emergency braking system (AEB). Alternatively or additionally thereto, the driver assistance system can be designed to output a warning of an obstacle in the surroundings of the motor vehicle and thus, for example, to suggest a manual actuation of the longitudinal guidance by a driver of the motor vehicle.

The driver assistance system relating to the longitudinal guidance of the motor vehicle is typically actuated in consideration of a predetermined time difference value. This describes a time difference which can lie between a triggering time of the driver assistance system and a collision time, at which a predicted collision of the motor vehicle with the obstacle takes place. The time difference can alternatively be referred to as the time to collision (TTC). When an obstacle is detected, with which the motor vehicle could collide, it is continuously checked whether the time difference value is already reached. As soon as it is reached, for example, a function of the driver assistance system, such as autonomous emergency braking of the motor vehicle, is triggered and/or the warning message is output. The time difference value is typically provided as a permanently predetermined value, which can be stored in the driver assistance system.

However, a situation can occur in which, for example, a velocity at which the motor vehicle approaches an obstacle in the moment in which, for example, the obstacle is detected is too large to be able to prevent the collision with the obstacle by means of the driver assistance system in consideration of the predetermined time difference value. The driver assistance system thus cannot be reasonably operated in every situation.

US 2018/0257646 A1 discloses a vehicle control device comprising a rear-end collision impact safety system, which can carry out a safety control in case of the risk of a rear-end collision.

It is the object of the invention to provide a solution, by means of which a driver assistance system for a motor vehicle can be operated particularly reasonably.

The object is achieved by the subjects of the independent claims.

A first aspect of the invention relates to a method for operating a driver assistance system for a motor vehicle relating at least to a longitudinal guidance of a motor vehicle. The driver assistance system is preferably designed to actuate the longitudinal guidance of the motor vehicle at least semiautomatically, in particular fully automatically.

The invention is at least based on the finding that the driver assistance system cannot be reasonably operated in every situation with a permanently predetermined time difference value (time to collision, TTC). The time difference value is therefore to be changeable at least in certain situations. A situation-dependent increase of the time difference value is particularly reasonable, in order to prevent a collision with an obstacle even more reliably in comparison to the operation of the driver assistance system using a permanently predetermined time difference value.

The method comprises providing sensor information, which describes at least one other motor vehicle located in front of the motor vehicle in a direction of travel of the motor vehicle. The other motor vehicle is, for example, another motor vehicle driving in front of the motor vehicle. The other motor vehicle can be located on a lane on which the motor vehicle itself is traveling and/or which is adjacent to the lane on which the motor vehicle is traveling. The other motor vehicle can currently be traveling or can be at a standstill. The sensor information describes, for example, all other motor vehicles which are located in a capture area of a sensor device that captures and provides the sensor information. The capture area is, for example, at least a part of the surroundings of the motor vehicle in a front area of the motor vehicle. It can be provided that the direction of travel of the other motor vehicle corresponds to the direction of travel of the motor vehicle, so that, for example, an oncoming other motor vehicle which is moreover located, for example, on a different lane than the motor vehicle, is not taken into consideration. In this way, the method can be restricted to the consideration of the sensor information which describes only other motor vehicles traveling ahead of and/or at a standstill in front of the motor vehicle and excludes, for example, motor vehicles of oncoming traffic. In general, however, any other motor vehicle described by the sensor information can be taken into consideration.

The sensor information is preferably transmitted to a control device of the motor vehicle and thus provided thereto. The control device can then provide the sensor information.

The control device is a computing unit and is designed to evaluate the sensor information for the further method steps of the method. The method steps described hereinafter are preferably all carried out by means of the control device of the motor vehicle. The control device is moreover designed to operate the driver assistance system, i.e. to execute at least one function of the driver assistance system. The control device is therefore designed, for example, to generate at least one control command for, for example, the braking system of the motor vehicle and provide it to the braking system.

The method comprises determining hazard warning light information by applying a hazard warning light detection criterion to the provided sensor information. The hazard warning light information describes whether the at least one other motor vehicle has an activated hazard warning light or not. It is thus deliberately checked whether the respective other vehicle described by the sensor information currently has an activated hazard warning lights system or not. The hazard warning light is implemented, for example, by means of lighting units of the other motor vehicle. When the warning light is activated, typically all turn signals of the other motor vehicle are switched on simultaneously and flash. The other motor vehicle travels with activated hazard warning light, for example, whenever a following road user is to be notified of, for example, abrupt deceleration of the motor vehicle, an end of traffic congestion, the last vehicle of a column, an accident, towing of another vehicle, and/or an upcoming driving maneuver of a bus, in particular a school bus or transit bus. Alternative or additional situations can exist in which the other motor vehicle activates the hazard warning light. The other motor vehicle which travels and/or stands with activated hazard warning light is therefore a clear indication of a possible obstacle for the motor vehicle. For this reason, it is established according to the invention whether at least one other motor vehicle in the surroundings of the motor vehicle has activated its hazard warning light. The hazard warning light detection criterion is, for example, an algorithm and/or a rule, on the basis of which the sensor information is evaluated to establish which other motor vehicle described by the sensor information currently has the activated hazard warning light and which does not.

If, according to the determined hazard warning light information, the at least one other motor vehicle has the activated hazard warning light, a time difference value is increased by a predetermined time interval. The time difference value describes a time difference which lies, in particular is permitted to lie, at most between a triggering time of a function of the driver assistance system and a collision time of a predicted collision of the motor vehicle with an obstacle in the surroundings of the motor vehicle. The time difference value is typically designated in the context of driver assistance systems as the time to collision (TTC) or time to collision value. The time difference value can be, for example, 1.4 seconds. In this case, the function of the driver assistance system is triggered at latest 1.4 seconds before a calculated predicted time of the collision of the motor vehicle with the obstacle, i.e. 1.4 seconds before the collision time. The function of the driver assistance system comprises, for example, at least semiautomatic, in particular fully automatic braking of the motor vehicle and/or outputting a warning message in the motor vehicle. The obstacle can be the other motor vehicle having the activated hazard warning light and/or another object in the surroundings of the motor vehicle. Instead of the predicted collision of the motor vehicle with the obstacle, a predicted collision of the motor vehicle with the at least one other motor vehicle that has the activated hazard warning light can thus be assumed.

The predetermined time interval is a fixed time value. The time interval is, for example, 0.5 seconds. In the above-mentioned example, the time difference value is therefore increased from 1.4 seconds originally by 0.5 seconds to a total of 1.9 seconds.

The driver assistance system is thereupon operated in consideration of the increased time difference value. Thus, for example, 1.9 seconds is assumed as the predetermined time difference value by the driver assistance system and no longer the original 1.4 seconds. Therefore, a reaction time, in which the function of the driver assistance system is activated, is extended, since the at least semiautomatic deceleration of the motor vehicle or another function of the driver assistance system is begun earlier than with the original time difference value. A strength of the function of the driver assistance system can remain unchanged.

By way of the method, by considering the hazard warning light information, a potentially hazardous situation is detected particularly quickly and therefore, for example, braking or another function of the driver assistance system can be activated particularly early. This early activation is achieved by increasing the time difference value. In this way, particularly reliable operation of the driver assistance system is possible.

One advantageous exemplary embodiment provides that the predetermined time interval is determined at least in consideration of an intrinsic velocity of the motor vehicle. The time interval by which the time difference value is increased is thus not constant but rather depends at least on how fast the motor vehicle is currently traveling. The intrinsic velocity can be determined by means of a sensor of the motor vehicle designed for this purpose. The sensor captures, for example, odometry data. The faster the motor vehicle travels, i.e. the higher the intrinsic velocity is, the greater the predetermined time interval can be selected to be, for example. Instead of the above-mentioned 0.5 seconds, the time interval can be increased, for example, by 0.7 seconds, 1 second, or even longer than 1 second. If the motor vehicle travels slowly, for example, 30 km/h or even less, the time interval can be reduced, for example, to only 0.3 seconds. Time intervals other than the time intervals mentioned as examples here are possible. In this way, depending on the situation, the time difference value is always selected which is reasonable on the basis of the current velocity of the motor vehicle.

A further exemplary embodiment provides that the predetermined time interval is determined at least in consideration of a relative velocity of the motor vehicle in relation to the at least one other motor vehicle. Thus, for example, not only the intrinsic velocity of the motor vehicle can have an influence on the time interval, but also the velocity difference between the motor vehicle and the other motor vehicle. It is therefore taken into consideration how fast the motor vehicle travels in comparison to the other motor vehicle which has activated the hazard warning light. The relative velocity thus specifies the intrinsic velocity relative to a velocity of the other motor vehicle. If the other motor vehicle is already at a standstill, for example, the relative velocity is greater than in a situation in which the other motor vehicle is still traveling and therefore has a velocity greater than 0 km/h. The higher the relative velocity is, the greater the predetermined time interval typically is. To determine the relative velocity, for example, the sensor information and/or the determined or measured intrinsic velocity of the motor vehicle can be evaluated. A particularly reasonable predetermined time interval is determined in that the relative velocity of the motor vehicle is taken into consideration.

The determined time interval is always taken into consideration when increasing the time reference value. It can be at least temporarily stored for this purpose in a storage unit of the control device.

It is provided in a preferred exemplary embodiment that if multiple other motor vehicles have the activated hazard warning light, distance information is determined for each of the multiple other motor vehicles. The distance information describes a distance between the motor vehicle and the respective other motor vehicle. The distance information can be determined, for example, in consideration of the sensor information. For this purpose, for example, sensor information can be evaluated which describes a distance to a respective object in the surroundings of the motor vehicle. The sensor information evaluated here can be captured and provided, for example, by a radar device, a lidar device, and/or an ultrasonic sensor. Alternatively or additionally thereto, the distance information can be determined from a camera image and therefore from static and/or moving image data of a camera unit. Known methods for determining a distance between the motor vehicle and an object in the surroundings of the motor vehicle, such as the other motor vehicle here, can be used.

The relative velocity of the motor vehicle in relation to the other motor vehicle, for which the smallest distance information is determined, is then taken into consideration. It is thus checked for which of the multiple other motor vehicles the smallest distance information was determined. This other motor vehicle is then selected as the single other motor vehicle and taken into consideration in the scope of the method. The remaining other motor vehicles can then be neglected, for example. When the time interval is determined, only the relative velocity with respect to the selected other motor vehicle is thus taken into consideration. Since the motor vehicle having the smallest distance information is the other motor vehicle arranged closest to the motor vehicle, in this way the expected potential obstacle for the motor vehicle is taken into consideration, since the other motor vehicle having activated hazard warning light arranged closest to the motor vehicle particularly probably represents the obstacle for the motor vehicle. In this way, the collision risk with the obstacle, i.e. with the precisely one selected other motor vehicle, can be prevented particularly reliably.

In this exemplary embodiment, the other motor vehicle having the smallest distance information can be a motor vehicle which travels on an adjacent lane and therefore not on the same lane as the motor vehicle. The selected other motor vehicle can be an obstacle which is arranged laterally to the motor vehicle and in particular not on its predicted travel trajectory. It is presumed that it can be the case with a motor vehicle traveling or standing having activated hazard warning light that an occupant will in particular leave this vehicle suddenly and become an obstacle for the motor vehicle. In that the other motor vehicle having activated hazard warning light, which is located on the adjacent lane, is taken into consideration here, the time difference value is increased as a precaution with regard to such a situation. This can be reasonable above all in an intra-urban region, in which it is relatively probable that an occupant of the other motor vehicle will leave it.

A further exemplary embodiment provides that if multiple other motor vehicles have the activated hazard warning light, it is determined which of these other motor vehicles are located on the same lane as the motor vehicle. The lane is in this case a lane of a road on which both the motor vehicle and the multiple other motor vehicles travel. Distance information is only determined for the other motor vehicle determined in this case. The distance information is thus only determined for the other motor vehicles or for at least the one other motor vehicle which are or is located on the same lane as the motor vehicle. The distance information describes, analogously to how it was described above, a distance between the motor vehicle and the determined other motor vehicle. The relative velocity of the motor vehicle in relation to the determined other motor vehicle, for which the smallest distance information was determined, is taken into consideration. Thus, if distance information was determined for multiple other motor vehicles on the same lane here, the distance information is also selected which is smallest and takes into consideration the associated other motor vehicle as the only motor vehicle. The motor vehicle is thus typically identified in this case which travels on the lane of the motor vehicle directly in front of the motor vehicle. Therefore, motor vehicles on adjacent lanes, in particular in the case of an expressway having multiple lanes, are not taken into consideration, but only the other motor vehicle toward which the motor vehicle travels directly because it is on the same lane. In this way, the method is deliberately tailored to a possibly imminent frontal collision of the motor vehicle with the other motor vehicle traveling in front and therefore to a typical collision situation in road traffic.

One particularly preferred exemplary embodiment provides that the predetermined time interval is determined at least in consideration of the determined smallest distance information. It can thus, for example, be taken into consideration, additionally or alternatively to the intrinsic velocity and/or the relative velocity, how far away the closest other motor vehicle of the multiple motor vehicles is still located from the motor vehicle. Depending on how far away this other motor vehicle is from the motor vehicle, the time interval can thus be predetermined as larger or smaller. This results in a time interval adapted in a particularly differentiated manner to the situation.

According to an additional exemplary embodiment, it is provided that it is checked whether the intrinsic velocity of the motor vehicle is greater than a predetermined velocity difference value. The velocity difference value is a value predetermined for the driver assistance system. It describes a velocity difference, by which the intrinsic velocity is reducible at most by means of the driver assistance system. It is assumed here that the driver assistance system cannot semiautomatically decelerate the motor vehicle from any arbitrary intrinsic velocity to a standstill, but rather that the at least semiautomatic velocity reduction which can be achieved by means of the driver assistance system is restricted to a maximum velocity difference. This is described by the velocity difference value. This can be, for example, 60 km/h.

If the intrinsic velocity is greater than the predetermined velocity different value, the time difference value is increased by a predetermined other time interval which is greater than the predetermined time interval. It can thus be the case that in a motor vehicle which travels at 120 km/h, for example, a velocity difference value is permanently predetermined which is below this intrinsic velocity of the motor vehicle, for example, at 60 km/h, for example. In this example, the current intrinsic velocity of 120 km/h is reduced semiautomatically, in particular fully automatically by means of the driver assistance system to at most the intrinsic velocity of 60 km/h. Thereafter, for example, remaining braking to a standstill or to a velocity less than 60 km/h has to be carried out manually, for example, by actuation of a brake pedal of the motor vehicle by the driver of the motor vehicle. To take into consideration that this driver possibly reacts with a delay, since he depends on the driver assistance system, the time difference value is increased by an even greater time interval than was heretofore provided. For example, the time interval is defined, instead of the 0.5 seconds mentioned as an example, at 1 second, 1.5 seconds, 2 seconds, or even longer. It is provided that the time difference value is increased here by the predetermined other time interval instead of the predetermined time interval. If there is a restriction of the braking function of the driver assistance system, a reasonable additional increase of the time difference value can thus take place.

In a further exemplary embodiment, it is provided that the predetermined other time interval is determined at least in consideration of a reaction time for a reaction of the driver of the motor vehicle. A driver-specific or driver-dependent reaction time can be known and taken into consideration, for example. This can be saved, for example, in a user profile of the driver, which can be stored in the motor vehicle and/or loaded therein if it is provided by an external computing unit. Alternatively or additionally thereto, the reaction time is generally predetermined. The generally predetermined reaction time can be, for example, between 1 second and 3 seconds. The time interval is then, for example, at least the reaction time, in particular it is the time interval determined in consideration of the intrinsic velocity, the relative velocity, and/or the smallest distance information plus the reaction time. In this way, an additional safeguard is achieved by taking into consideration the reaction time of the driver.

In an additional exemplary embodiment, it is provided that the hazard warning light information is continuously determined and checked. Checking is to be understood to mean that it is checked whether according to the hazard warning light information at least one other motor vehicle having activated hazard warning light has been detected or whether, for example, no other motor vehicle having activated hazard warning light has been detected. As soon as it is established that according to the determined hazard warning light information, no other motor vehicle has the activated hazard warning light, the time difference value is reduced again by the predetermined time interval and the driver assistance system is again operated in consideration of the reduced time difference value. In other words, the increase of the time difference value is only maintained as long as at least one other motor vehicle having activated hazard warning light is detected by evaluating the sensor information. As soon as no other motor vehicle located in the capture area of the sensor device of the motor vehicle which provides the sensor information has still activated its hazard warning light, the previously increased time difference value is reduced again to its starting value. The time difference value is thus reset again to the original time difference value. In this way, it is clear that the method according to the invention is only intended for special situations and chronologically unlimited changing of the predetermined time difference value is not intended.

According to an additional exemplary embodiment, it is provided that the function of the driver assistance system comprises warning of the predicted collision, braking preparation of at least one brake of a braking system of the motor vehicle, and/or braking by means of the at least one brake of the braking system. The driver assistance system can thus only be designed for warning of a collision and therefore, for example, can indicate a time from which braking should be performed for the driver of the motor vehicle. The warning message output in this context is provided in consideration of the increased time difference value. An output unit can be provided in the motor vehicle for the warning, for example. The output unit can be designed for acoustic and/or optical output. The output unit is thus, for example, a display unit, such as a display screen, in particular a touch-sensitive display screen, and/or a head-up display, on the one hand, and/or a loudspeaker unit having at least one loudspeaker, on the other hand. The output unit can be a component of the motor vehicle and/or can be comprised by a mobile terminal positioned in the motor vehicle, in particular a smartphone or tablet. The control device transmits, for example, the measure for warning, such as the warning message, to the output unit.

The braking preparation as a function can be, for example, a preparation for an upcoming braking maneuver by means of the at least one brake of the braking system. The brake can be brought for this purpose, for example, by means of at least one mechanical, pneumatic, and/or hydraulic measure into a preliminary status for braking. This has the effect that if necessary particularly rapid braking is subsequently possible by means of the brake. It is preferably provided that the driver assistance system can actually actuate at least one brake of the braking system, and therefore actually carries out braking, in particular braking to a standstill. The driver assistance system is thus a driver assistance system which relates to the longitudinal guidance of the motor vehicle in various ways.

A further exemplary embodiment provides that the driver assistance system is an autonomous emergency braking system and/or an adaptive cruise control system. The autonomous emergency braking system is often referred to as autonomous emergency braking (AEB). The adaptive cruise control system can alternatively be referred to as an adaptive cruise control (ACC). Driver assistance systems are thus preferably provided which are actually designed to actuate the at least one brake of the braking system at least semiautomatically, in particular fully automatically.

In addition, an exemplary embodiment provides that the sensor information is captured by means of a sensor device of the motor vehicle. The sensor device is in particular a camera and/or a lidar device. The sensor device is thus preferably an imaging sensor designed to generate a static and/or moving or dynamic depiction of the surroundings. The sensor information thus comprises image data, for example, in the case of the camera. The sensor device is preferably the front camera of the motor vehicle. Alternatively or additionally thereto, the sensor information can be provided by an external unit, in particular by another motor vehicle, a traffic observation camera, and/or a traffic monitoring computing unit, such as a backend, a server, and/or a cloud server. The transmission of the sensor information to the motor vehicle can be based, for example, on vehicle-to-vehicle and/or vehicle-to-infrastructure communication.

A further aspect of the invention relates to a motor vehicle for carrying out the method described. The motor vehicle is thus designed to carry out the method described above. The motor vehicle is, for example, a passenger car, a truck, a bus, a motorcycle and/or a moped. The motor vehicle can have a control device.

A further aspect of the invention relates to a control device for a motor vehicle, which is designed to carry out the method described above. The control device carries out the described method, in particular an exemplary embodiment or a combination of exemplary embodiments of the described method. The control device has a processor unit. The processor unit can comprise at least one microprocessor and/or at least one microcontroller and/or at least one FPGA (field-programmable gate array) and/or at least one DSP (digital signal processor). Furthermore, the processor device can have program code, which can alternatively be referred to as a computer program product. The program code may be stored in a data memory of the processor device.

Another aspect of the invention relates to a computer program product. The computer program product is a computer program. The computer program product comprises instructions which, when the program is executed by a computer, for example by the control devices of the motor vehicle, cause the computer to carry out the steps of the method according to the invention.

The exemplary embodiments described in connection with the method according to the invention, both individually and in combination with each other, apply accordingly, insofar as applicable, to the motor vehicle according to the invention, the control device according to the invention and the computer program product according to the invention. The invention comprises combinations of the described exemplary embodiments.

In the figures:

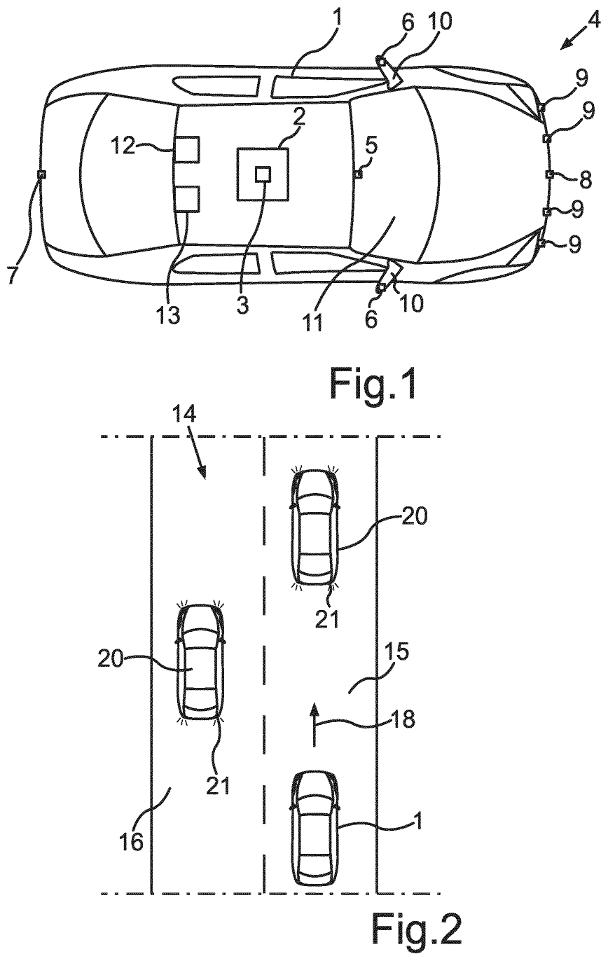

FIG. 1 shows a schematic illustration of a motor vehicle having a sensor device;

FIG. 2 shows a schematic illustration of multiple motor vehicles on a road;

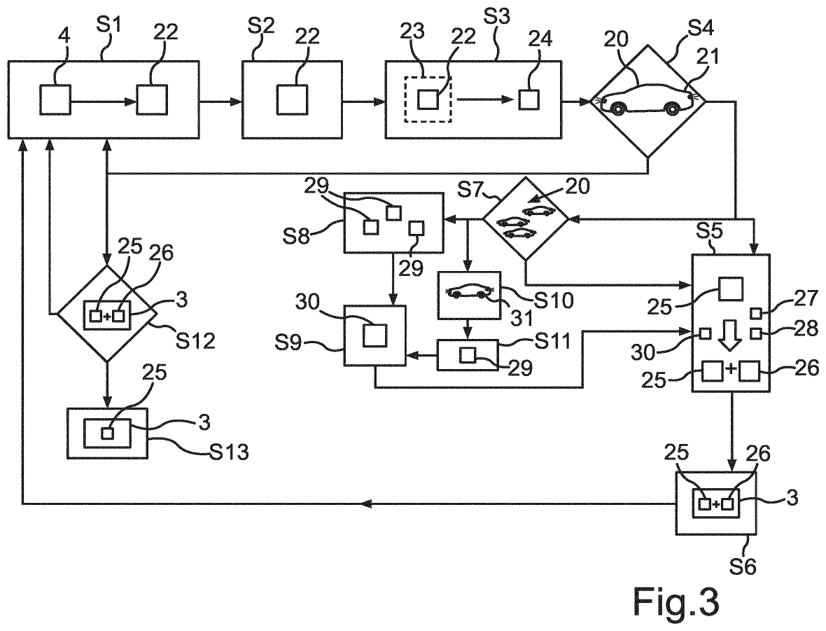

FIG. 3 shows a schematic illustration of a signal flow chart of a method for operating a driver assistance system relating at least to a longitudinal guidance of the motor vehicle; and

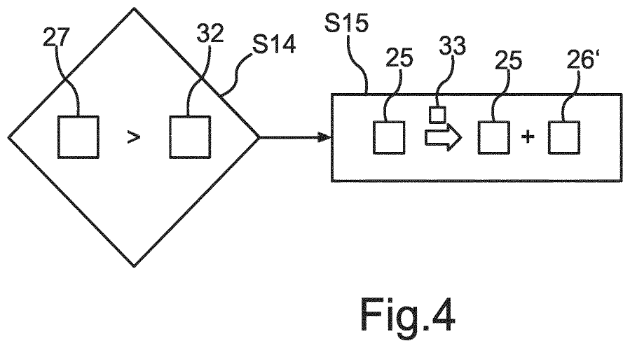

FIG. 4 shows a schematic illustration of a signal flow chart of further method steps of a method according to FIG. 3.

FIG. 1 schematically shows a motor vehicle 1, which has a control device 2. The control device 2 is a computing unit of the motor vehicle 1 and can have, for example, a driver assistance system 3, which has at least one function. The driver assistance system 3 relates at least to a longitudinal guidance of the motor vehicle 1. The driver assistance system 3 is, for example, an autonomous emergency braking system and/or an adaptive cruise control system. The function of the driver assistance system 3 can carry out a warning before a predicted collision of the motor vehicle 1 with an obstacle. Alternatively or additionally thereto, the function of the driver assistance system 3 can carry out a braking preparation of at least one brake of a braking system 12 of the motor vehicle 1.

Alternatively or additionally thereto, the function of the driver assistance system 3 can carry out at least semiautomatic, in particular fully automatic braking by means of the at least one brake of the braking system 12.

The motor vehicle 1 has a sensor device 4. The surroundings of the motor vehicle 1 can be captured by means of the sensor device 4. The sensor device 4, as shown by way of example here, can comprise multiple cameras, such as a front camera 5, a side camera 6, and/or a rear camera 7. The sensor device 4 preferably comprises at least the front camera 5. Alternatively or additionally thereto, the sensor device 4 can have a lidar device 8, a radar device 9, and/or an ultrasonic sensor (not shown here). The side cameras 6 are arranged here in side mirrors 10 of the motor vehicle 1. The front camera 5 is arranged in an area of a windshield 11 of the motor vehicle 1 arranged at the top in a vertical direction of the motor vehicle 1. Multiple radar devices 9 and/or lidar devices 8 and/or ultrasonic sensors can be arranged in the motor vehicle 1. Solely by way of example, multiple such sensors for a front area of the motor vehicle 1 are schematically shown here, which can be arranged in a bumper of the motor vehicle. At least the surroundings of the motor vehicle 1 in the front area of the motor vehicle 1 can be captured by means of these sensors.

An output unit 13 can be arranged in the motor vehicle 1, such as a display screen, in particular a touch-sensitive display screen, a head-up display, and/or a loudspeaker unit which comprises at least one loudspeaker. The output unit 13 can be a component of the motor vehicle 1 and/or can be comprised by a mobile terminal which is positioned in the motor vehicle 1. The mobile terminal is, for example, a smartphone and/or tablet. If the function of the driver assistance system 3 provides the warning before the predicted collision, a warning message can be output by means of the output unit 13.

FIG. 2 shows a road 14 on which the motor vehicle 1 is traveling. The road 14 has a right lane 15 and a left lane 16. The same direction of travel 18 applies for both lanes 15, 16. In addition to the motor vehicle 1, two other motor vehicles 20 are also located on the road 14 here solely by way of example. These travel in the direction of travel 18 in front of the motor vehicle 1 on the road 14. One of the two other motor vehicles 20 travels on the same lane 15, 16 as the motor vehicle 1, i.e. on the right lane 15. The other motor vehicle 20 travels on the adjacent left lane 16. Both other motor vehicles 20 have an activated hazard warning light, i.e. all light units 21 of the respective other motor vehicle 20 flash, for example, in order to warn of a potential obstacle, such as an end of congestion.

FIG. 3 shows steps of a method for operating the driver assistance system 3 relating at least to the longitudinal guidance of the motor vehicle 1. In a method step S1, the sensor information 22 can be captured by means of the sensor device 4. The sensor device 4 in method step S1 preferably comprises at least the front camera 5, in particular moreover the side cameras 6 and/or the lidar device 8. The sensor information 22 is provided in a method step S2 by means of the control device 2. The sensor information 22 describes at least one other motor vehicle 20 located in front of the motor vehicle 1 in the direction of travel 18 of the motor vehicle 1.

In a method step S3, a hazard warning light detection criterion 23 is applied to the provided sensor information 22. In this way, hazard warning light information 24 is determined, which describes whether the at least one other motor vehicle 20 has an activated hazard warning light or not. In a method step S4, it is checked whether at least one other motor vehicle 20 having activated hazard warning light was determined or not. If this is the case, a time difference value 25 is increased in a method step S5. The time difference value 25 describes a time difference which lies at most between a triggering time of the function of the driver assistance system 3 and a collision time of a predicted collision of the motor vehicle 1 with an obstacle, such as the other motor vehicle 20 in particular. The time difference value 25 is increased here by a predetermined time interval 26. In a method step S6, the driver assistance system 3 is thereupon operated in consideration of the increased time difference value 25, i.e. the sum of the original time difference value 25 and the predetermined time interval 26.

It can be provided that the predetermined time interval 26 is initially determined and an intrinsic velocity 27 of the motor vehicle 1 is taken into consideration in this case. This is determined, for example, in the motor vehicle 1, in particular by means of a sensor of the motor vehicle 1 designed for this purpose. Alternatively or additionally thereto, in the determination of the time interval 26, a relative velocity 28 can be taken into consideration, which describes the relative velocity of the motor vehicle 1 in relation to the at least one other motor vehicle 20. The relative velocity 28 is thus a deviation of the intrinsic velocity 27 in relation to a velocity of the other motor vehicle 20. The relative velocity 28 can be determined, for example, in consideration of data of the radar device 9, the ultrasonic sensor, and/or the lidar device 8.

Furthermore, after method step S4, it can be checked in a method step S7 whether multiple other motor vehicles 20 have the activated hazard warning light. Three other motor vehicles 20 are schematically shown here by way of example, which travel or stand with activated hazard warning light. Distance information 29 is thereupon determined for each of the multiple other motor vehicles 20. This takes place in a method step S8. The respective distance information 29 describes a distance between the motor vehicle 1 and the other motor vehicle 20. Only the other motor vehicles 20 which have an activated hazard warning light are taken into consideration in this case. Therefore, three items of distance information 29 are determined in the example outlined here.

A smallest item of distance information 30 is thereupon selected from the determined items of distance information 29. The relative velocity 28 of the motor vehicle 1 in relation to precisely the other selected motor vehicle 20 for which the smallest item of distance information 30 was determined is thereupon taken into consideration. It can therefore be provided that in the determination of the predetermined time interval 26, the determined smallest item of distance information 30 is taken into consideration.

Instead of the consideration of all other motor vehicles 20 which are described by the sensor information 22, it can be provided in a method step S10 that it is established after method step S7 which of the other motor vehicles 20 that have the activated hazard warning light is located on the same lane 15, 16 as the motor vehicle 1. This is precisely one other motor vehicle 20 here, for example, which is schematically shown here as the determined other motor vehicle 31. Only for the determined other motor vehicle 31, in a method step S11, the distance information 29 is determined which describes the distance between the motor vehicle 1 and the determined other motor vehicle 31. If multiple determined other motor vehicles 31 are determined, the relative velocity 28 of the motor vehicle 1 in relation to precisely the determined other motor vehicle 31 is taken into consideration for which the smallest item of distance information 30 was determined, i.e. method step S9 takes place.

In method steps S8 and S9, however, in principle any other motor vehicle 20 can be taken into consideration without method steps S10 and S11, even if, for example, it is located on the adjacent lane 15, 16 to the lane 15, 16 of the motor vehicle 1. With reference to FIG. 2, the relative velocity 28 in relation to the other motor vehicle 20 traveling on the left lane 16 can thus be taken into consideration, since this vehicle has a lesser distance to the motor vehicle 1 than the other motor vehicle 20 traveling directly in front of the motor vehicle 1 on the right lane 15. In method steps S10, S11 and then S9, however, this other motor vehicle 20 is not taken into consideration at all, but rather only the other motor vehicle 20 traveling directly ahead and therefore likewise traveling on the right lane 15.

It can furthermore be provided that the hazard warning light information 24 is continuously checked. As soon as it is established that according to the determined hazard warning light information 24, no other motor vehicle 20 still has the activated hazard warning light, the time difference value 25 is again reduced by the predetermined time interval 26. The driver assistance system 3 is then again operated in consideration of the reduced time difference value 25 and therefore in consideration of the original time difference value 25. It can be provided that if it is established in method step S4 that according to the determined hazard warning light information 24, no other motor vehicle 20 having activated hazard warning light was established, method step S1 can be carried out directly again.

Moreover, a method step S12 can be provided, in which it is checked whether the driver assistance system 3 is currently operated according to the increased time difference value 25. If this is the case, in a method step S13, the time difference value 25 can again be reduced by the time interval 26. If it is established in the check that currently the driver assistance system 3 is not operated at all using the increased time difference value 25, method step S1 is likewise carried out again. If it is established, for example, in method step S7 that multiple other motor vehicles 20 do not have the activated hazard warning light at all, method step S5 can take place.

FIG. 4 schematically shows two optional method steps S14 and S15. In method step S14, it is checked whether the intrinsic velocity 27 of the motor vehicle 1 is greater than a predetermined velocity difference value 32. The velocity difference value 32 is permanently predetermined for the driver assistance system 3. It describes a velocity difference by which the intrinsic velocity 27 of the motor vehicle 1 is reducible at most by means of the driver assistance system 3. The case is thus described here that the driver assistance system 3 cannot decelerate from any arbitrary intrinsic velocity 27 to a standstill, but rather only, for example, by the velocity difference of, for example, 60 km/h. If this is the case, in a method step S15, the time difference value 25 is increased by a predetermined other time interval 26′, which is greater than the predetermined time interval 26. For the predetermined other time interval 26′, at least one reaction time 33 for a reaction of a driver of the motor vehicle 1 is taken into consideration. The reaction time 33 can be predetermined specifically by driver for this purpose. If the intrinsic velocity 27 is less than or equal to the velocity difference value 32, the method can be ended or method step S5 can take place. It is thus possible to carry out method step S14 after method step S4 or S7 and replace method step S5 with method step S15. After method step S15, method step S6 is preferably carried out, but in consideration of the time difference value 25 which was increased by the predetermined other time interval 26′.

Overall, the examples show a time difference value threshold value adjustment by detection of the hazard warning light system of the other motor vehicle 20 in front. The ego vehicle (motor vehicle 1) detects the hazard warning light system of the other motor vehicles 20 in front using optical sensors, such as the front camera 5 or the lidar device 8. The motor vehicle 1 increases the time difference value 25 (TTC threshold values) of the driver assistance system 3 (for example, for FCW (forward collision warning), pre-fill, and brake). The increase can take place dynamically depending on the intrinsic velocity 27 and/or the relative velocity 28 in relation to the most critical other motor vehicle 20.

On an expressway, the motor vehicle 1 travels at 120 km/h. In front of it, some other motor vehicles 20 have the hazard warning light system on and are not moving, which indicates congestion. A typical driver assistance system configuration has a time difference value 25 (TTC threshold) of 1.4 seconds. With this intrinsic velocity 27 and relative velocity 28 and with a typical deceleration on dry roads of 9 m/s per second, this has the result that the motor vehicle 1 brakes when the distance to the other motor vehicle 20 in front is 46.66 m. In order that the motor vehicle 1 comes to a stop without collision, however, it requires 61.67 m, which means that the collision cannot be avoided here.

However, if the time difference value 25 (TTC threshold value) is increased to 1.9 seconds (an addition of 0.5 seconds), the motor vehicle 1 brakes when the distance to the other motor vehicle 20 in front is still 63.33 m, and comes to a stop when the distance is 1.66 m. The collision is thus avoided here.

1. A method for operating a driver assistance system relating at least to a longitudinal guidance of a motor vehicle, comprising:
providing sensor information describing at least one other motor vehicle located in front of the motor vehicle in a direction of travel of the motor vehicle;
determining hazard warning light information which describes whether the at least one other motor vehicle has an activated hazard warning light or not, by applying a hazard warning light detection criterion to the provided sensor information;
when, according to the determined hazard warning light information, the at least one other motor vehicle has the activated hazard warning light, increasing a time difference value, which describes a time difference that lies at most between a triggering time of a function of the driver assistance system and a collision time of a predicted collision of the motor vehicle with an obstacle in the surroundings of the motor vehicle, by a predetermined time interval; and
operating the driver assistance system in consideration of the increased time difference value.

2. The method as claimed in claim 1, wherein the predetermined time interval is determined at least in consideration of an intrinsic velocity of the motor vehicle.

3. The method as claimed in claim 1, wherein the predetermined time interval is determined at least in consideration of a relative velocity of the motor vehicle in relation to the at least one other motor vehicle.

4. The method as claimed in claim 3, wherein when multiple other motor vehicles have the activated hazard warning light, an item of distance information is determined for each of the multiple other motor vehicles, which describes a distance between the motor vehicle and the other motor vehicle, and the relative velocity of the motor vehicle in relation to the other motor vehicle for which a smallest item of distance information was determined is taken into consideration.

5. The method as claimed in claim 3, wherein when multiple other motor vehicles have the activated hazard warning light, the method comprises:
determining which of these other motor vehicles are located on a same lane as the motor vehicle; and
determining an item of distance information, which describes a distance between the motor vehicle and the determined other motor vehicle, for the respective determined other motor vehicle,
wherein the relative velocity of the motor vehicle in relation to the determined other motor vehicle is taken into consideration, for which a smallest item of distance information was determined.

6. The method as claimed claim 4, wherein the predetermined time interval is determined at least in consideration of the determined smallest item of distance information.

7. The method as claimed in claim 2, wherein it is checked whether the intrinsic velocity of the motor vehicle is greater than a predetermined velocity difference value, which is predetermined for the driver assistance system and describes a velocity difference by which the intrinsic velocity is reducible at most by means of the driver assistance system, wherein when the intrinsic velocity is greater than the predetermined velocity difference value, the time difference value is increased by a predetermined other time interval, which is greater than the predetermined time interval.

8. The method as claimed in claim 7, wherein the predetermined other time interval is determined at least in consideration of a reaction time for a reaction of a driver of the motor vehicle.

9. The method as claimed in claim 1, wherein the hazard warning light information is continuously determined and checked, wherein when it is established that according to the determined hazard warning light information, no other motor vehicle has activated hazard warning light, the time difference value is reduced again by the predetermined time interval and the driver assistance system is operated again in consideration of the reduced time difference value.

10. The method as claimed in claim 1, wherein the function of the driver assistance system comprises a warning of the predicted collision, a braking preparation of at least one brake of a braking system of the motor vehicle, and/or braking by means of the at least one brake.

11. The method as claimed in claim 1, wherein the driver assistance system is an autonomous emergency braking system and/or an adaptive cruise control system.

12. The method as claimed in claim 1, wherein the sensor information is captured by means of a camera and/or a lidar device of the motor vehicle.

13. A motor vehicle which is designed to carry out a method as claimed in claim 1.

14. A control device for a motor vehicle which is designed to carry out the steps, provided for the control device, of a method as claimed in any one of claim 1.

15. A computer program product comprising instructions which, when the program is executed by a computer, cause the computer to perform a method as claimed in claim 1.
